(19) United States
(12) Patent Application Publication
(10) Pub. No.: US 2010/0295655 A1
(43) Pub. Date: Nov. 25, 2010

(54) Power-generating unit for a tire sensor module

(75) Inventor: Thorsten Pannek, Stuttgart (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/308,494

(22) PCT Filed: Nov. 9, 2007
(86) PCT No.: PCT/EP2007/062145

§ 371 Date: Aug. 9, 2010

(30) Foreign Application Priority Data
Jan. 9, 2007 (DE) 10 2007 001 361.4

(51) Int. Cl. G05B 23/02; H02N 2/18

(52) U.S. Cl. 340/3.1; 310/339

(57) ABSTRACT

A power-generating unit for a tire sensor module of a vehicle tire has: a piezoelectric element, which is displaceable between a first stable bent position and a second stable bent position and outputs a piezoelectric voltage upon the displacement between the stable bent positions, and a restoring unit for the mechanical displacement of the piezoelectric element from the first stable bent position into the second stable bent position, the restoring unit being activatable by a deformation acting on the power-generating unit, e.g., in a deformed tire area of the vehicle tire above its tire contact patch. The piezoelectric element is clamped in receptacles at its end areas and has two oppositely arched stable bent positions having unstable intermediate states.

The present invention relates to a power-generating unit for a tire sensor module, a tire sensor module having a power-generating unit of this type, and a vehicle tire having a tire sensor module of this type.

### BACKGROUND INFORMATION

Sensor modules are used in vehicle tires for measuring state variables, e.g., the tire pressure, the tire temperature, the occurring forces, and the coefficient of friction. The sensor modules must, inter alia, be supplied with electric power for operating their sensor elements and for transmitting signals to a vehicle-side transceiver.

On the one hand, sensor modules having galvanic elements, i.e., batteries, are known for this purpose. However, their service life is limited; furthermore, environmental pollution occurs upon the disposal of the vehicle tire.

Therefore, sensor modules having an autonomous power supply are known. In general, the stress or the deformation occurring in the tire is converted into power. The use of piezoelectric films made of organic material such as PVDF (poly vinylidene fluoride) is known for this purpose. The films do deliver enough power, but they are subject to low temperature stability and therefore degenerate relatively rapidly. Furthermore, the connection of the films to the sensor is difficult. Wiring is already problematic for reasons of reliability.

### SUMMARY OF THE INVENTION

The present invention is based on the idea of accommodating a piezoelectric element in such a way that it assumes stable positions in two different bent states. These bent states may be arches in particular, in that the piezoelectric element is clamped at its diametrically opposed ends and an upward or downward arch may form between the clamped areas. Two stable bent positions having unstable intermediate areas are thus formed. The piezoelectric element is advantageously mechanically pre-tensioned for this purpose, to implement stable bent positions.

The displacement between the two bent positions is performed in a first direction via a mechanical restoring unit, which reaches the piezoelectric element in the event of sufficient mechanical deformation and resets it into the other stable bent position. The transition in the area of the tire contact patch is advantageously used as the deformation.

The inertial force acting on the piezoelectric element and preferably supplementary mass elements, i.e., in particular the centrifugal force, is advantageously used as the displacement in the opposing second direction. This is based on the finding according to the present invention that only tangential, but no radial forces and thus also no centrifugal forces act on the piezoelectric element and its additional mass elements in the tire contact patch, so that the displacement force to be applied by the mechanical restoring unit is limited in the first direction.

Therefore, two displacements between the two stable end positions are possible during one tire rotation, namely upon the transition of the sensor module into the area of the tire contact patch and upon leaving this area, energy being obtained in each case.

A high mechanical stress and in this way a high electric voltage and high electric power may be achieved by the high mechanical bending deformations between the stable bent positions, in particular in the event of two different arches.

According to the present invention, a piezocomposite may be produced from at least two layers, e.g., a substrate layer and a piezoelectric layer made of a ceramic material, e.g., PZT, which allows a high mechanical reliability, a high electric output voltage or high power output, and in particular higher temperature stability than organic materials. Because the two layers have different coefficients of thermal expansion, a mechanical pre-tension is formed, because of which the electric voltage which may be output is increased further.

Through the high power output according to the present invention, a sensor module having one or more sensor elements, a transceiver, and further electronic components may be operated autonomously.

The piezoelectric element is preferably clamped in a housing part or a receptacle fixed on a housing. Secure fastening and advantageously also direct electrical contacting are thus made possible, without providing additional sensitive cables or further fasteners for this purpose. The restoring unit may be connected directly to another housing part placed further outward radially in the tire, which is more greatly subjected to the deformations, so that the relative movement of the restoring unit in relation to the piezoelectric element is achieved.

According to the present invention, a high degree of integration and thus small overall size, as well as a secure accommodation of the sensitive parts, may be achieved by the attachment of the piezoelectric element directly in the housing. In particular, the attachment of the sensor module directly in the running surface of the tire and thus direct measurement of the relevant state variables, e.g., also the vibrations, are also possible, the high mechanical deformations occurring there resulting in a high power yield.

### BRIEF DESCRIPTION OF THE DRAWINGS

FIG. 1 shows a vehicle tire having a sensor module according to the present invention during its rolling movement in a side view;

FIG. 2 shows a power-generating unit according to one embodiment in a first bent position outside the tire contact patch;

FIG. 3 shows the power-generating unit in a second bent position in the tire contact patch;

FIG. 4 shows an illustration of the piezoelectric element in the bent positions.

### DETAILED DESCRIPTION OF THE EXEMPLARY EMBODIMENTS

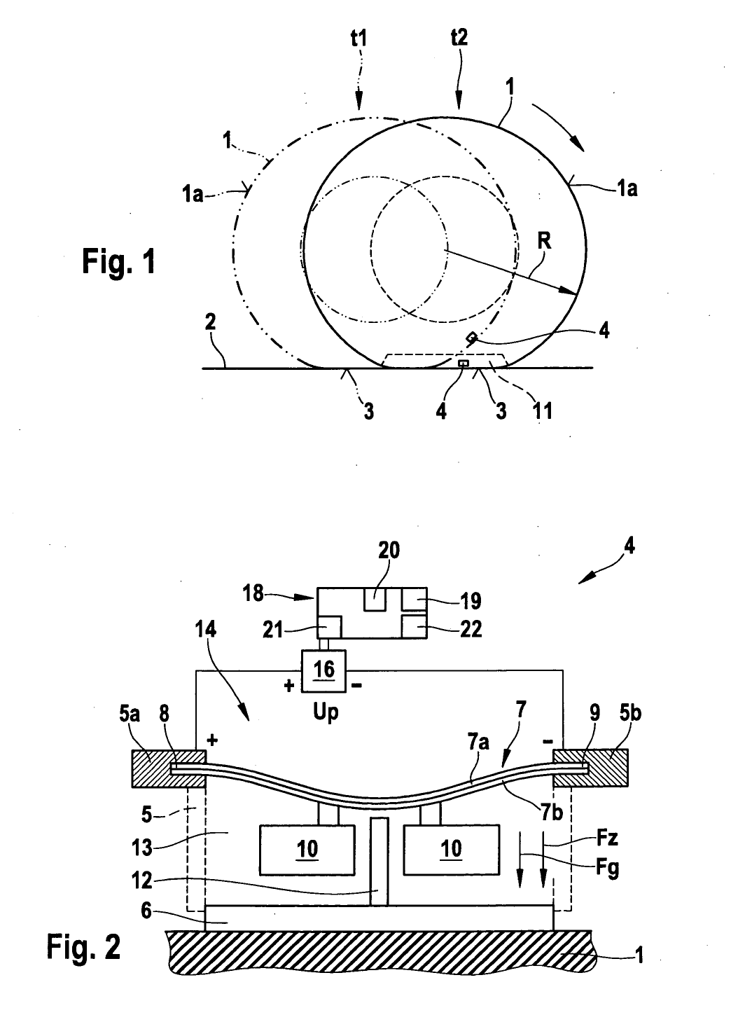

A tire 1 of one of the wheels of a vehicle rolls during travel on a roadway 2. The positions in two sequential instants t1, t2 are shown in FIG. 1. Tire 1 has an essentially uniformly curved shape in its external surface 1a outside its tire contact patch 3 and its tire contact patch 3 presses flatly and/or evenly on roadway 2, so that a deformed tire area 11 is implemented above tire contact patch 3.

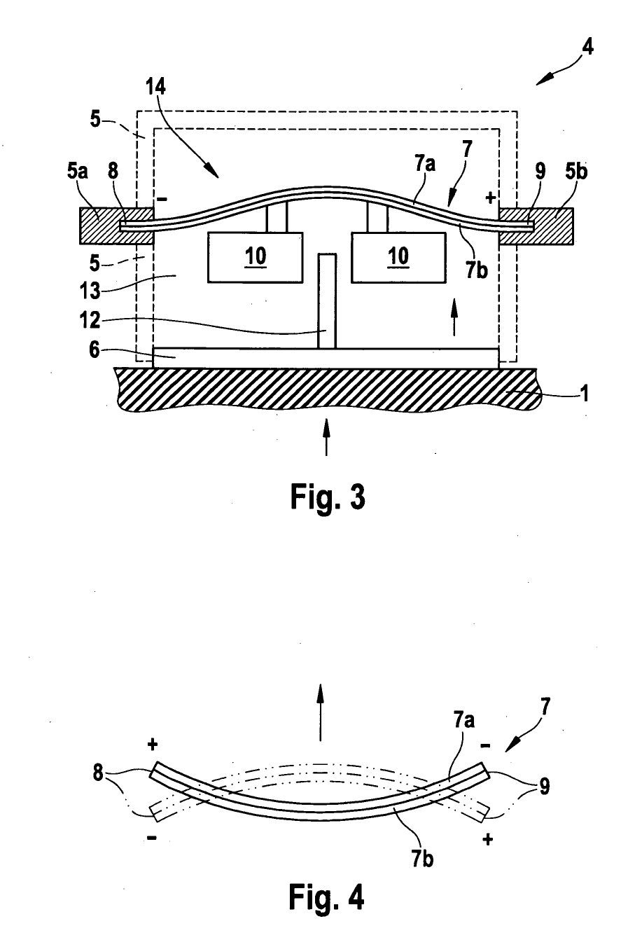

A sensor module 4 according to the present invention is accommodated in tire 1. Sensor module 4 has a housing 5, 6, partially shown schematically by dashed lines in FIGS. 2, 3, which is deformable or displaceable under compressive stress according to the present invention. For this purpose, the housing may have a housing top part 5 and a housing bottom part 6, for example. Housing bottom part 6 is displaceable in relation to housing top part 5 in vertical or—in relation to tire 1—radial direction R. For this purpose, housing bottom part 6 may be implemented integrally with housing top part 5 and as elastically displaceable, for example. Furthermore, a two-part implementation having separate housing top part 5 and housing bottom part 6 is possible, in which housing bottom part 6 is guided so it is displaceable in housing top part 5, for example. It is relevant according to the present invention that a relative displacement is possible between housing top part 5 and housing bottom part 6 in radial direction R, and nonetheless sufficient sealing of housing inner chamber 13 in relation to the strains during the vulcanization into the rubber material of the tire is achieved. For the sake of clarity, only the bottom area of housing top part 5 is shown in FIG. 2.

A piezoelectric element 7 is implemented in housing inner chamber 13 as a piezoelectric composite material having multiple, preferably two, layers 7a, b which are connected to one another, e.g., bonded, at least one layer 7a being manufactured from a piezoelectric ceramic material, preferably PZT (lead zirconate titanate). Second layer 7b is manufactured from another material having a different coefficient of thermal expansion than piezoelectric layer 7a, so that entire piezoelectric element 7 obtains a mechanical pre-tension, as shown in FIG. 4. Piezoelectric element 7 implements a piezoelectric voltage Up, whose polarity is a function of the direction of the arch, at its ends 8, 9 being used for the voltage tap, i.e., the ends of its piezoelectric layer 7a, in accordance with its mechanical deformation or its mechanical sag.

Piezoelectric element 7 may thus relax from its unstable, horizontal, strongly tensioned intermediate position by arching upward or downward into one of the two stable bent positions. In the lower bent position of FIG. 2, upper piezoelectric layer 7a is compressed under pressure and outputs a piezoelectric voltage Up of a first polarity, lower second layer 7b used as the substrate being under tensile stress. Correspondingly, in the upper bent position of FIG. 3, upper piezoelectric layer 7a is under tensile stress and outputs a piezoelectric voltage Up of a second, opposing polarity, lower second layer 7b used as the substrate being compressed under pressure. Piezoelectric voltage Up correspondingly alternates its sign in the event of an alternating bending strain.

The shape of piezoelectric element 7 may be selected in accordance with the desired modulus of elasticity and the required electric voltage. A circularly symmetrical shape, i.e., an implementation of piezoelectric element 7 which is arched in the fundamental state, i.e., in the form of a spherical shell and/or spherical cap, like a “snap clicker,” may be selected.

Piezoelectric element 7, which is formed as a piezocomposite from two layers 7a, 7b, snaps completely through as a bistable system between the two arch states, by which a high deflection and thus a high electric output power are achieved.

Multilayer piezoelectric element 7 is accommodated fixed at its ends 8 and 9 in housing receptacles 5a, b of housing top part 5. Housing receptacles 5a, b are also used for the electrical contact of ends 8, 9 of piezoelectric element 7, in addition to the mechanical clamping of piezoelectric element 7. A mass unit, e.g., as shown in FIGS. 2, 3, two mass elements 10 or also, for example, an annular, continuous mass element 10, may be attached to piezoelectric element 7 in a middle area between its ends 8, 9. Mass elements 10 may fundamentally be fastened on the top or bottom side of piezoelectric element 7.

An upwardly projecting mandrel 12 is fastened on housing bottom part 6, which, in the upper bent position shown in FIG. 2, projects up to slightly below the middle of piezoelectric element 7, but does not deform it. Sensor module 4 is accommodated in the running surface of tire 1 in such a way that housing bottom part 6 having mandrel 12 is situated radially further outward and housing top part 5 having piezoelectric element 7 is situated radially further inward, so that housing bottom part 6 is displaced toward housing top part 5 upon the deformation of tire 1 during its rolling movement, so that mandrel 12 is pressed upward and acts against the mechanical pre-tension of the downwardly arched piezoelectric element 7 and against the inertial force exerted by piezoelectric element 7 and the at least one mass element 10. Inertial force Fg acting on piezoelectric element 7 and mass element 10 is composed of gravitation force Fg=m×g, with g≈10 m/s², and centrifugal force Fz=v²/r, with r=radius of curvature of the path of piezoelectric element 7. Outside tire contact patch 3 and/or deformed tire area 11, the radius of curvature essentially corresponds to tire radius R; in planar tire contact patch 3, r=infinite, i.e., a tangential movement is described, in which the centrifugal force becomes zero; the centrifugal force also disappears or initially assumes a very low value upward in deformed tire area 11 adjoining tire contact patch 3.

Outside deformed tire area 11, i.e., over a majority of the rotational movement, power-generating unit 14 is in the bottom bent position shown in FIG. 2. The at least one mass element 10 is accelerated radially outward by centrifugal force Fz of rotating vehicle tire 1; the radial component of gravitation force Fg acting on mass element 10 is a function of the orientation and/or rotational position of power-generating unit 14 in tire 1, but is very slight in relation to centrifugal force Fz and also pre-tension force F of piezoelectric element 7.

As soon as sensor module 4 together with its power-generating unit 14 arrives at the bottom in deformed tire area 11 above tire contact patch 3, housing bottom part 6 is displaced upward in relation to housing top part 5 and its mandrel 12 presses piezoelectric element 7 upward against its pre-tension and against centrifugal force Fz acting on mass element 10, until the piezoelectric element snaps through upward after reaching a middle position and thus assumes the upper bent position shown in FIG. 3.

In deformed tire area 11 above flat tire contact patch 3, sensor module 4 and thus power-generating unit 14 are solely subjected, as described above, to the tangential movement, i.e., only a negligible tangential component of the acceleration acts on power-generating unit 14, namely the acceleration of the vehicle in the longitudinal direction or X direction and gravitation force Fg in the radial direction perpendicular to the tire surface, i.e., in the vertical Z direction here. It is thus recognized according to the present invention that no centrifugal forces arise in tire contact patch 3 itself and the force acting downward on piezoelectric element 7 is thus very small and is only a function of the mass of mass element 10 and the intrinsic mass of piezoelectric element 7.

If sensor module 4 together with power-generating unit 14 leaves deformed area 11 above flat tire contact patch 3, it again enters an orbit essentially having radius R of tire 1 and is thus subjected to a radial acceleration dependent on the rotational speed of tire 1, which may be between a few hundred and 10,000 m/s², depending on the velocity.

Significantly higher centrifugal forces Fz thus act in the radial direction toward tire surface 1a outside tire contact patch 3 and draw piezoelectric element 7 back into the downwardly arched bent position of FIG. 2. The total mass of piezoelectric element 7 and mass element 10 is adapted in such a way that centrifugal force Fz is sufficient to cause piezoelectric element 7 to snap back again.

It is fundamentally possible according to the present invention for a relatively small elastic spring action to be additionally implemented between housing top part 5 and housing bottom part 6, which presses housing bottom part 6 back outward again outside tire contact patch 3.

During the displacements from the bent position of FIG. 2 into the bent position of FIG. 3 and also the restoring procedure, piezoelectric voltages Up having a differing polarity and/or a differing sign are generated. Housing receptacles 5a, 5b used for the contacting are connected to a rectifier circuit 16 according to the schematic illustration of FIG. 2, which outputs the rectified voltage to a further electrical circuit 18 of sensor module 4. Electrical circuit 18 has, inter alia, sensor 19 of sensor module 4 which is read out electrically, as well as a control unit 22, a transceiver 20 for the signal transmission to and from a corresponding transceiver on the vehicle, and advantageously an energy store 21, e.g., a capacitor, which also ensures a power supply in the periods of time between the deformation, i.e., during the remaining tire rotation outside tire contact patch 3.

Sensor 19 may be used, for example, for measuring the tire pressure, the acceleration, the temperature, and/or the coefficient of friction. Furthermore, additional electrical functions of electrical circuit 18 are also possible.

1-15. (canceled)

16. A power-generating unit for a tire sensor module of a vehicle tire, comprising:
a piezoelectric element configured to be displaceable between a first stable bent position and a second stable bent position, wherein the piezoelectric element outputs a piezoelectric voltage upon displacement between the first and second stable bent positions; and
a restoring unit configured to provide mechanical displacement of the piezoelectric element from the first stable bent position into the second stable bent position, wherein the restoring unit is configured to be activated by a deformation acting on the power-generating unit.

17. The power-generating unit as recited in claim 16,
wherein the restoring unit is configured to be activated when the power-generating unit is situated above a tire contact patch in a deformed tire area of the vehicle tire.

18. The power-generating unit as recited in claim 17,
wherein, in a position outside the deformed tire area, a centrifugal force exerted on the piezoelectric element during rotation of the vehicle tire presses the piezoelectric element into the first stable position.

19. The power-generating unit as recited in claim 17, wherein at least one mass element for increasing a centrifugal force acting upon the wheel rotation is provided on the piezoelectric element.

20. The power-generating unit as recited in claim 17, wherein opposing end areas of the piezoelectric element are clamped in corresponding receptacles, and wherein the piezoelectric element has two oppositely arched stable bent positions and unstable intermediate states.

21. The power-generating unit as recited in claim 20,
wherein the receptacles are connected to a first housing area, and the restoring unit is connected to a second housing area, wherein the second housing area is displaced relative to the first housing area by the deformation acting on the power-generating unit.

22. The power-generating unit as recited in claim 21,
wherein the second housing area is a housing bottom part which presses the restoring unit against the piezoelectric element from below in the event of a force action, and wherein a counter force is exerted by an elastic restoring force of the piezoelectric element and by inertial forces of the piezoelectric element.

23. The power-generating unit as recited in claim 20, wherein the receptacles for the opposing end areas of the piezoelectric element are configured to electrically contact and tap the piezoelectric voltage.

24. The power-generating unit as recited in claim 20, wherein the piezoelectric element has at least two layers which are connected to one another, the two layers having different coefficients of thermal expansion and having a mechanical pre-tension in relation to one another, and wherein at least one of the two layers is a piezoelectric layer for outputting the piezoelectric voltage upon displacement between the two stable bent positions.

25. The power-generating unit as recited in claim 24,
wherein the piezoelectric layer is made from a ceramic piezoelectric material.

26. The power-generating unit as recited in claim 20, further comprising:
a rectifier circuit for rectifying the piezoelectric voltage of differing polarity.

27. The power-generating unit as recited in claim 20, wherein the restoring unit is a mandrel which projects upward and substantially centrally against the piezoelectric element.

28. A self-powered tire sensor module for attachment in a vehicle tire, comprising:
a power-generating unit including:
a piezoelectric element configured to be displaceable between a first stable bent position and a second stable bent position, wherein the piezoelectric element outputs a piezoelectric voltage upon displacement between the first and second stable bent positions; and
a restoring unit configured to provide mechanical displacement of the piezoelectric element from the first stable bent position into the second stable bent position, wherein the restoring unit is configured to be activated by a deformation acting on the power-generating unit;
a sensor configured to measure a state variable of a vehicle tire; and
a transceiver configured to provide signal exchange with a transceiver provided on the vehicle;
wherein the power-generating unit supplies the sensor and the transceiver with electric power.

29. The tire sensor module as recited in claim 28, further comprising:
an energy store for storing the power generated by the power-generating unit.

30. The tire sensor module as recited in claim 28, wherein the tire sensor module is attached to a road-contact surface of the vehicle tire.
